(19) United States
(12) Patent Application Publication
(10) Pub. No.: US 2007/0263236 A1
(43) Pub. Date: Nov. 15, 2007

(54) Automatic discovery of print media attributes

(76) Inventor: Senthil K. Selvaraj, Redmond, WA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/414,280

(22) Filed: Apr. 27, 2006

(51) Int. Cl. H04N 1/60

(52) U.S. Cl. 358/1.9

(57) ABSTRACT

A technique is provided for automatically discovering the values of attributes of print media disposed in input bins of a printing device. A driver process associated with the printing device queries a configuration file to retrieve information pertaining to the input bins. Based on the information, a request is generated and sent to the printing device. The query may include an identifier that identifies an attribute of a print medium currently disposed in an input bin of the printing device. The printing device receives the request and queries a database associated with the printing device. The printing device retrieves, from the database, a value associated with the identifier. The driver process receives the value from the printing device and updates a variable, corresponding to the attribute, with the value.

### FIELD OF THE INVENTION

The present invention relates to media discovery, and more particularly to automatically discovering attributes of print media in input bins associated with a printing device.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Printing devices are conventionally configured with one or more input bins that contain the media on which the printing devices print electronic data, such as electronic documents and pictures. Input bins of printing devices are capable are carrying a variety of print media. Not only may the size of print media vary, but also other attributes, such as thickness, color, orientation, type (e.g. transparent, glossy, flat), and whether a particular medium is pre-printed (e.g. company letterhead) may also vary.

In order to communicate with a printing device from a remote computer, a device driver for that device is installed on the remote computer. A device driver is a computer program that enables another program, typically an operating system, to interact with a hardware device, such as a printing device. In order to communicate properly with the printing device, the driver associated with that device must be configured properly.

For example, if a user wants to print data on print media oriented in a particular way, a user interface (UI) for the printer driver will indicate the orientation of the media in a particular input bin of the printing device. If the information indicated via the driver UI is incorrect, then printing jobs sent to the printing device will not be performed as the user desires.

One problem with current printer drivers is that they require attributes of the print media contained in input bins to be set manually. When a printer driver is installed, the printer driver typically shows only the default media attributes corresponding to the input bins. Manually setting the media attributes in a printer driver user interface is tedious, time-consuming, and may result in the printer not functioning if the attributes are incorrectly set. Such problems are amplified for large corporations where several hundred computers are networked with several hundred printers. If a single print media attribute changes on a single printing device, then every printer driver associated with that printing device must be manually updated to accurately reflect the change in the print media attribute. To compound the problem, current printers typically have several input bins. Therefore, many printer driver variables (where each variable indicates a value of a print media attribute in a particular input bin) may have to be separately configured if printing jobs destined for each input bin are to be processed properly.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates steps for automatically discovering a print media attribute, according to an embodiment of the invention;

FIG. 2 shows a functional block diagram of a system in which one embodiment of the present invention may be implemented;

FIG. 3 is a sequence diagram illustrating the communications between a printer driver and a printing device for automatically discovering an attribute of a print medium, according to an embodiment of the invention;

FIG. 4 is a data flow diagram that illustrates various components that implement the steps of automatic media discovery, according to an embodiment of the invention; and

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

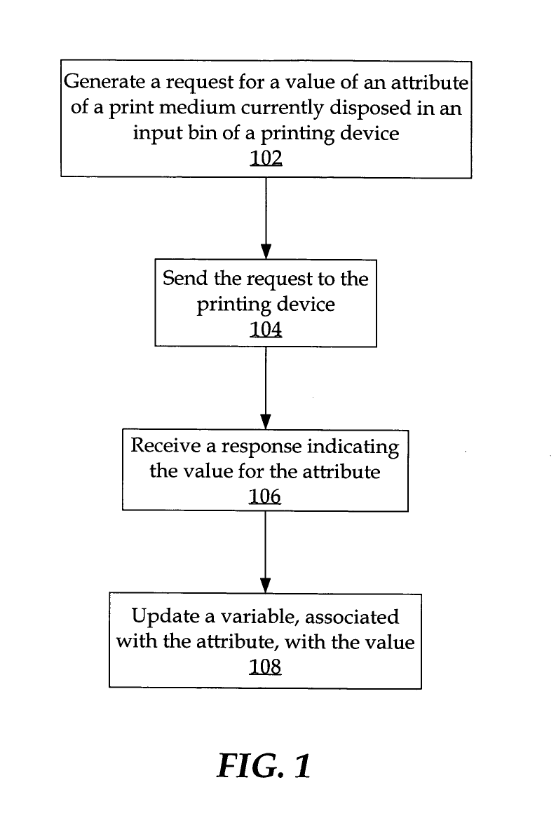

FIG. 1 is a flow diagram that illustrates steps for automatically discovering a print media attribute, according to an embodiment of the invention. At step 102, a request is generated for a value of an attribute of a print medium currently disposed in an input bin of a printing device. At step 104, the request is sent to the printing device. At step 106, a response is received from the printing device that indicates a value for the attribute. At step 108, a variable associated with the attribute is updated with the value.

### Architectural Overview

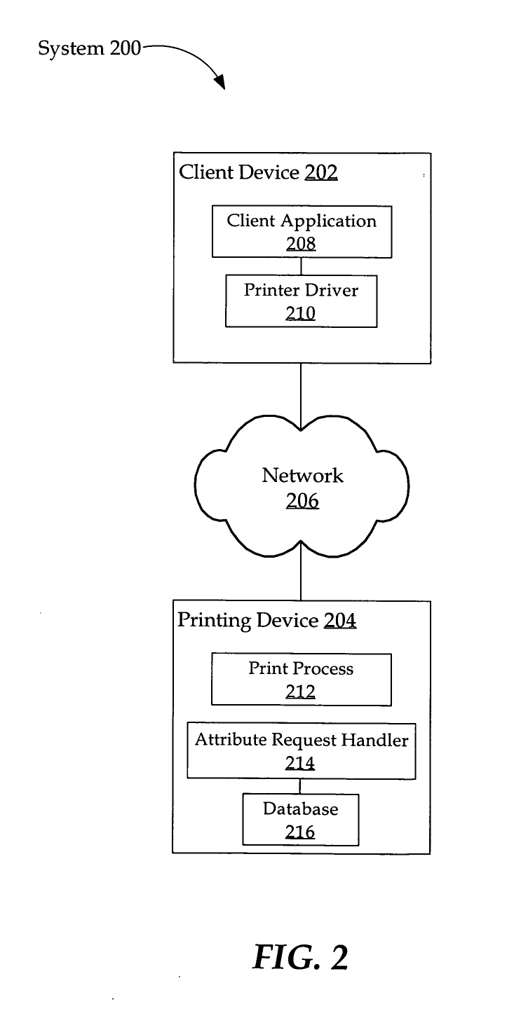

With reference to FIG. 2, there is shown a functional block diagram of a system 200 in which one embodiment of the present invention may be implemented. As shown, system 200 comprises a client device 202, a printing device 204, and a network 206. For the sake of simplicity, only one client device 202 and one printing device 204 are shown; however, there may be any number of client devices 202 and printing devices 204.

Client device 202 represents a client machine executing a client application 208 and a printer driver 210. Client application 208 may be any application that is capable of initiating requests for printing hard copies of electronic documents. Client application 208 may be, for example, a word processor that generates electronic documents or opens existing electronic documents for printing on printing device 204. Other examples of client applications 208 include, without limitation, spreadsheet programs, graphics programs, financial applications, etc.

Printer driver 210 may be any process that is capable of transmitting requests for printing documents. Printer driver 210 may be logically part of client application 208 or may be a separately executing process, as shown. Printer driver 210 controls communications between client device 202 and printing device 204. Printer driver 210 is used as an intermediary to translate communications from other computer programs into a language that printing device 204 can understand. The use of a printing driver facilitates printer device independence. For example, when client application 208 is a word processing program, the word processing program does not (conventionally) directly instruct printing device 204 on how to print a particular page from an electronic document. Instead, client application 208 may instruct an operating system associated with client device 202 to send the page that is to be printed to printing device 204. The operating system forwards the page to printer driver 210. Printer driver 210 converts the page into a format that printing device 204 can understand.

Printing device 204 represents a printing device executing 1) a print process 212 for handling requests for printing hard copies of electronic documents, 2) an attribute request handler 214 for handling requests for discovering attribute values of print media currently disposed in one or more input bins of printing device 204, and 3) a database 216 that stores attribute values of print media currently disposed in the one or more input bins. Print process 212 may be any process capable of receiving electronic documents from a client application (e.g. client application 208) or a printer driver (e.g. printer driver 210) and causing the electronic documents to be printed on one or more print media.

References herein to the term “printing device” are not limited to a device that provides only printing services. “Printing device” may be any device that is capable of performing printing functions. Many printing devices today provide functionality in addition to printing, e.g. copying and scanning, and therefore references to “printing device” include such devices. Also, a printing device may have any number of input bins.

Network 206 may be implemented by any medium or mechanism that provides for the exchange of data between various nodes in the network. Examples of network 206 include, without limitation, a network such as a Local Area Network (LAN), Wide Area Network (WAN), Ethernet or the Internet, or one or more terrestrial, satellite, or wireless links. Network 206 may include a combination of networks such as those described. Network 206 may transmit data according to Transmission Control Protocol (TCP) and Internet Protocol (IP).

### Automatic Discovery of Media Attributes

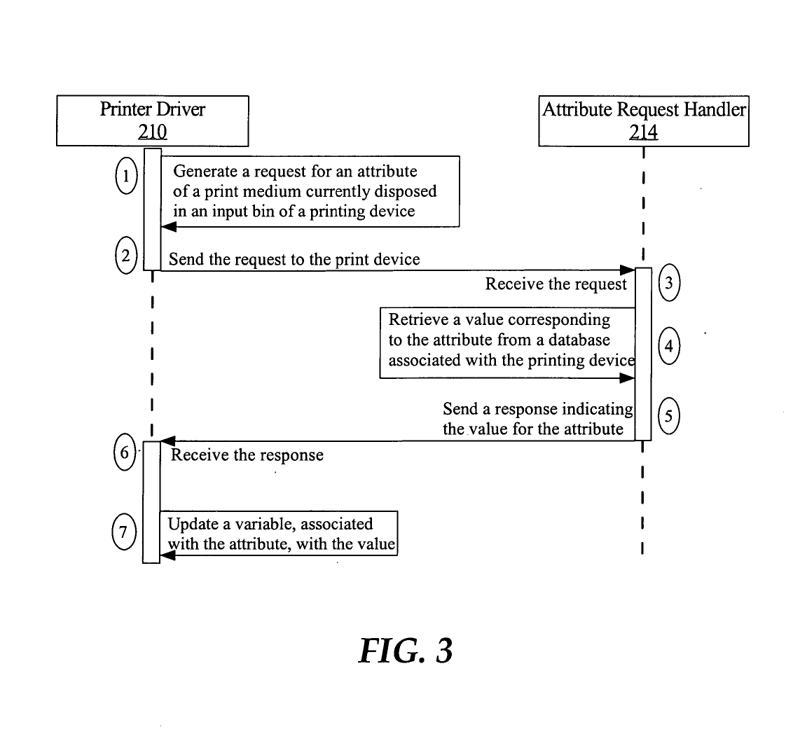

FIG. 3 is a sequence diagram illustrating the communications between printer driver 210 and attribute request handler 214 for automatically discovering an attribute of a print medium disposed in an input bin of a printing device, according to an embodiment of the invention. In step 1, printer driver 210 generates a request for an attribute of a print medium, wherein the print medium is currently disposed in an input bin of a printing device, e.g. printing device 204. In step 2, printer driver 210 sends the request to printing device 204 where the request is received (step 3), e.g. by attribute request handler 214. Based on the request, printing device 204 retrieves a value corresponding to the attribute, e.g. from database 216 (step 4). The data that contains the value may be stored locally on printing device 204 of may be stored remotely with respect to printing device 204. In step 5, printing device 204 sends a response indicating the value for the attribute, e.g. by attribute request handler 214 to printer driver 210 and the response is received (step 6). In step 7, printer driver 210 updates a variable associated with the attribute with the value.

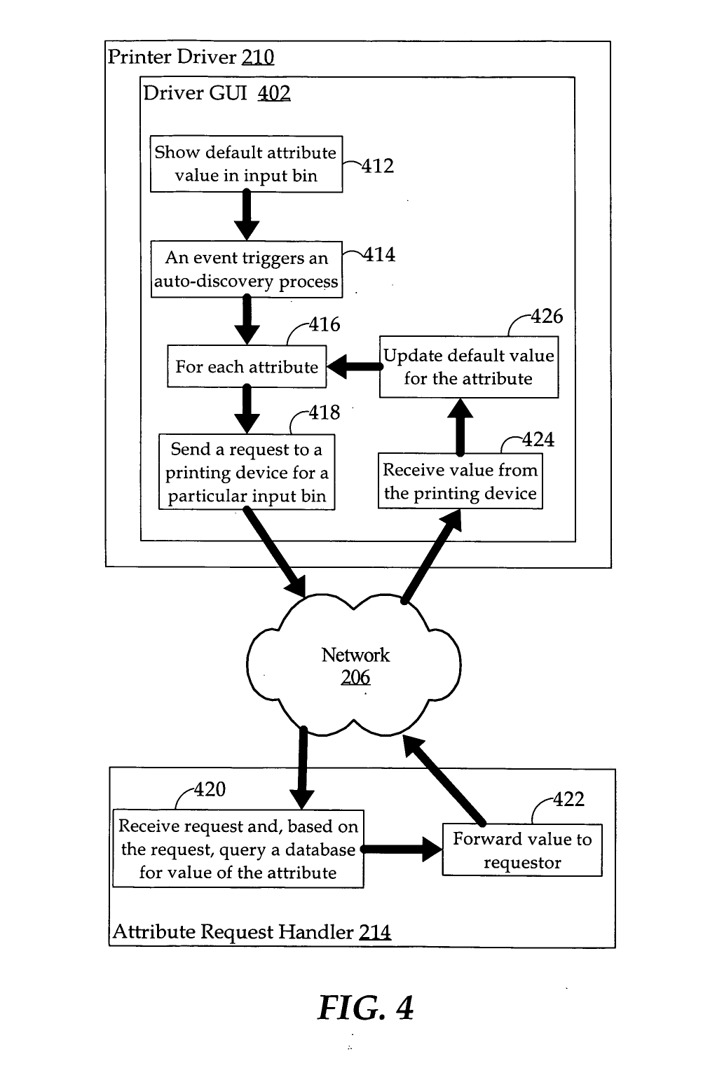

FIG. 4 is a data flow diagram that illustrates various example components that implement automatic media discovery, according to an embodiment of the invention. Printer driver 210 may have an associated graphical user interface (GUI) (e.g. a driver GUI 402) that allows a user to graphically view and update attributes of print media currently disposed in input bins of printing device 204.

Initially, in step 412, a default value of a particular attribute of a print medium may be shown via driver GUI 402 for each input bin in printing device 204. An event occurs (step 414) that triggers the automatic discovery of one or more attributes of print media currently disposed in one or more input bins of printing device 204.

Many events may trigger printer driver 210 to initiate an automatic discovery process. Such events may include, but are not limited to, when printer driver 210 is installed, when an update is detected on printing device 204, when a user submits input to initiate the process, and according to a periodic schedule.

According to one embodiment, when an event triggers printer driver 210 to initiate the automatic discovery process, a configuration file is accessed to retrieve one or more identifiers, such as an object identifier (OID), associated with one or more attributes of print media currently disposed in an input bin of printing device 204. Typically, every model of a printing device has a single common configuration file associated with the model. Thus, if all networked printing devices were of the same model, then only one configuration file may be necessary.

A configuration file for a printing device defines various characteristics for the printing device, such as the attributes of print media that may be detected for a particular input bin. A configuration file may be in XML format or another format, such as simple text. Because XML structured data is relatively easy and fast to parse, an XML-formatted configuration file allows the printer driver to query the file quickly.

The configuration file for a particular model of the printing device may reside on every machine that has a printer driver for the printing device (which provides for fast access) or the configuration file may reside on a separate machine that is accessed over a network. In this way, instead of having multiple copies of the configuration file (one for each machine that uses the services provided by the printing device), there is only one configuration file (for all printing devices of the same model). Or, a configuration file may reside on every machine and on the separate machine, where the default is to send a query for the identifiers to the configuration file that is stored remotely over the network. If the network is down, then the printer driver will access the locally stored configuration file.

Once an identifier is obtained, a request is sent to printing device 204, or a machine associated with printing device 204, whichever has access to database 216 that stores values for the attributes of the print media currently disposed in the input bins of printing device 204. Attribute request handler 214 receives the request, which includes the identifier, and uses the identifier to query database 216. The request may also include multiple identifiers indicating multiple attributes of a print medium disposed in a particular input bin. Furthermore, the request may include identifiers associated with different input bins so that multiple variables associated with multiple input bins may be updated by a single request. The number of identifiers and the number of input bins that correspond to those identifiers may be based upon the event that triggered printer driver 210 to initiate the auto-discovery process. Nevertheless, the following description is based on a request for the value of a single attribute of a print media currently disposed in a single input bin (step 418).

Thus, for each attribute (step 416), a request is sent from printer driver 210 to attribute request handler 214 over a network 206 (step 418). The request may be sent using Simple Network Management Protocol (SNMP). Other example communication protocols that printer driver 210 and attribute request handler 214 may use to exchange data and/or request with each other include, without limitation, Universal Plug and Play (UPnP) and Web Services Discovery (WSD). Any type of secure communication protocol may be used.

At step 420, attribute request handler 214 receives the request and queries database 216 associated with printing device 204 for the attribute. According to one embodiment, database 216 is a management information base (MIB). A MIB is a type of database used to manage one or more devices in a communications network. A MIB comprises a collection of objects in a database used to manage entities (e.g. printing devices) in a network. A MIB is hierarchical and entries in a MIB are addressed through OIDs, referred to above. MIBs typically only respond to SNMP or RMON (Remote Monitoring protocol) requests but may be configured to respond to requests based on other communication protocols, such as the protocols cited above.

The MIB of a printing device may be different for every printing device. Therefore, one MIB is typically associated with one printing device. The information stored in a MIB of a printing device may include the model of the printing device, the drivers supported by the printing device, available printing options, various print media supported by the printing device, the amount of memory on the printing device, and other information about the printing device itself.

When an attribute of a print media currently disposed in a particular input bin of the printing device changes, the MIB associated with the printing device is updated to reflect the change. Thus, when a request to update a print media attribute is subsequently received, the MIB will be queried by a process on the printing device (e.g. SNMP master agent) and the updated information will be returned.

Based on the identifier included in the request from printer driver 210, attribute request handler 214 retrieves a value associated with the identifier from database 216. The value is associated with a particular attribute of print media currently disposed in an input bin of printing device 204. For example, if the identifier indicates the size attribute for print media currently disposed in a particular input bin on printing device 204, then database 216 will be queried for the size of the print media currently disposed in the particular input bin. For example, the value retrieved from database 216 indicating the size of the print media may be “A4,” which indicates that the print media currently disposed in the particular input bin of printing device 204 is of size A4. As another example, the identifier may indicate the type attribute for print media currently disposed in the particular input bin. For example, the value retrieved from database 216 indicating the type of the print media may be “glossy,” which indicates that the print media currently disposed in the particular input bin of printing device 204 is of type glossy. As another example, the identifier may indicate whether the print media currently disposed in the particular input bin is pre-printed. For example, the value retrieved from database 216 indicating whether the print media is pre-printed may be “true,” which indicates that the print media currently disposed in the particular input bin of printing device 204 is pre-printed.

Once the value is retrieved from database 216, attribute request handler forwards the value to printer driver 210 (step 422) over network 206. At step 424, printer driver 210 receives the value and updates a variable with the value, wherein the variable is associated with the attribute indicated in the original request from printer driver 210 to attribute request handler 214. According to an embodiment, the variable corresponds to a GUI object associated with driver GUI 402, wherein a user may graphically view the updated variable. For example, the updated variable is a variable for the type of print media currently disposed in a particular input bin of printing device 204 and the value of “print media type” is “glossy.” When a user decides to print a document, the user may, using a graphical interface, select a “Property” button associated with printing device 204. The selection of the “Property” button may cause a GUI window to appear. The GUI window may comprise a plurality of tabs and buttons, one tab of which may be a “Paper/Quality” tab. By selecting the “Paper/Quality” tab, another GUI window may appear that indicates the attributes of print media currently disposed in the particular input bin of printing device 204. One of those attributes may be the print media “type” and, because the variable “print media type” associated with that particular input bin was updated to “glossy,” the other GUI window indicates that the type of print media in that particular input bin is “glossy.”

According to an embodiment, as step 416 indicates, the process for discovering attributes of print media currently disposed in one or more input bins of printing device 204 (steps 416-426) may continue for each attribute in which a user desires to see an update or in which printer driver 210 is configured to update. For example, steps 416-426 may execute automatically for each attribute of the print media in the particular input bin. Or, steps 416-426 may execute only when input is received from the user, such as in response to a prompt. Or, steps 416-426 may execute (e.g. in response to installation of a printer driver) for all attributes of print media in all input bins of the associated printing device.

Implementation Mechanisms

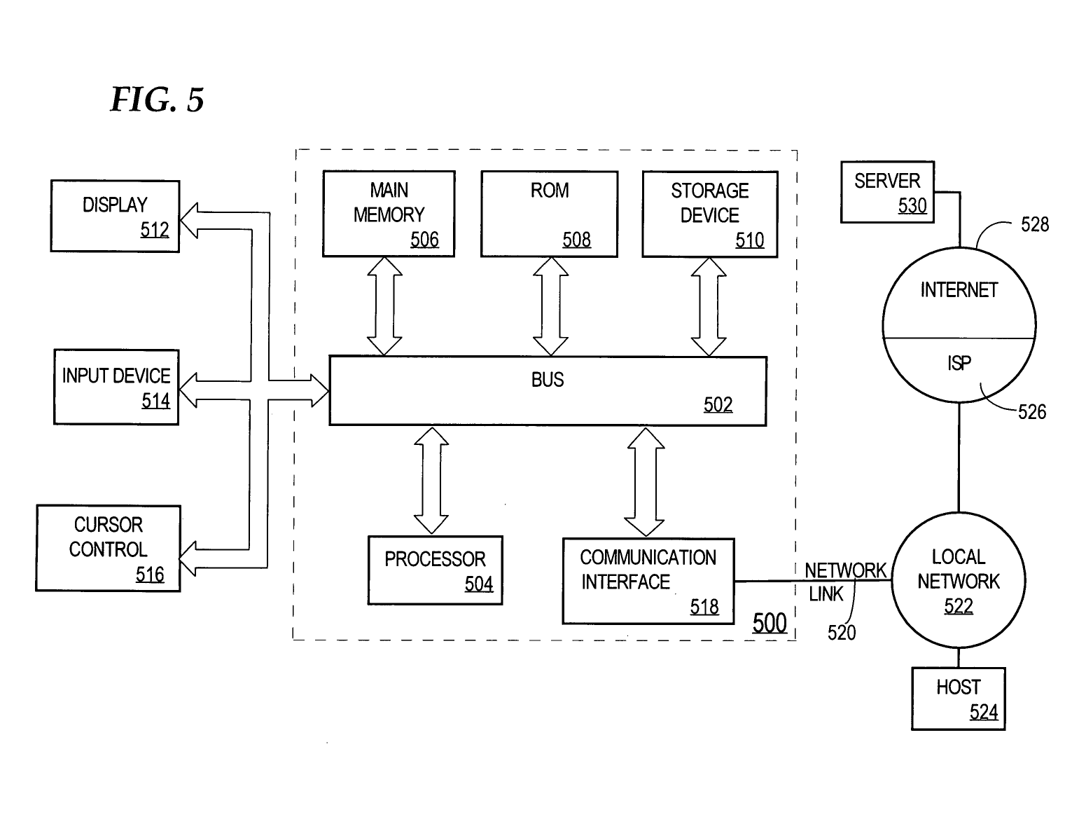

The approach described herein for automatically discovering print media attributes may be implemented on any type of computing platform or architecture. FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for the automatic discovery of a value of an attribute of a print medium, comprising:
generating a request for the value of the attribute of the print medium, wherein the print medium is currently disposed in an input bin of a printing device;
sending the request to the printing device;
receiving a response indicating the value for the attribute; and
updating a variable with the value, wherein the variable is associated with the attribute.

2. The method of claim 1, wherein:
the request includes an identifier;
the identifier identifies the attribute; and
based on the identifier, the printing device retrieves the value.

3. The method of claim 1, wherein the sending the request and receiving a response are performed using one of the following communication protocols: Simple Network Management Protocol, Universal Plug and Play, and Web Services Discovery.

4. The method of claim 1, wherein the printing device communicates with a database using the Simple Network Management Protocol.

5. The method of claim 1, wherein the request is sent to the printing device upon the occurrence of one of the following events:
a driver associated with the printing device is installed;
a detection of an update on the printing device;
a particular input from a user is received; and
a completion of a scheduled cycle.

6. The method of claim 1, wherein the attribute of the print medium includes one of the following attributes: thickness, size, type, color, orientation, and whether a particular medium is pre-printed.

7. The method of claim 1, wherein the generating a request comprises:
querying a configuration file associated with the printing device; and
retrieving, from the configuration file, an identifier that identifies the attribute.

8. The method of claim 7, wherein the configuration file is in XML format.

9. The method of claim 1, wherein:
a graphical user interface (GUI) is associated with the printing device; and
the variable corresponds to a GUI object associated with the GUI.

10. The method of claim 1, wherein the request identifies the input bin.

11. The method of claim 1, wherein:
the generating a request includes a printer driver generating the request;
the sending the request includes the printer driver sending the request;
the receiving a response includes the printer driver receiving the response; and
the updating a variable includes the printer driver updating the variable.

12. A computer-implemented method for the automatic discovery of a value of an attribute of a print medium, comprising:
receiving, from a requesting process, a request for the value of the attribute, wherein the print medium is currently disposed in an input bin of a printing device;
retrieving the value from a database associated with the printing device; and
sending, to the requesting process, a response that includes the value.

13. The method of claim 12, wherein the database is a management information base (MIB).

14. The method of claim 12, wherein:
the request includes an identifier;
the identifier identifies the attribute; and
the retrieving the value from a database comprises retrieving the value from a database, based on the identifier.

15. The method of claim 12, wherein the receiving a request and the sending a response are performed using one of the following communication protocols: Simple Network Management Protocol, Universal Plug and Play, and Web Services Discovery.

16. The method of claim 12, wherein the retrieving the value from a database is performed using the Simple Network Management Protocol.

17. The method of claim 12, wherein the request is received upon the occurrence of one of the following events:
a driver associated with the printing device is installed;
a detection of an update on the printing device;
a particular input from a user is received; and
a completion of a scheduled cycle.

18. The method of claim 12, wherein the attribute includes one of the following attributes: thickness, size, type, color, orientation, and whether a particular medium is pre-printed.

19. The method of claim 12, wherein the request identifies the input bin.

20. A computer-readable medium for the automatic discovery of a value of an attribute of a print medium, the computer-readable medium carrying one or more sequences of instructions which, when executed by one or more processors, cause the one or more processors to perform the computer-implemented steps of:
generating a request for the value of the attribute of the print medium, wherein the print medium is currently disposed in an input bin of a printing device;
sending the request to the printing device;
receiving a response indicating the value for the attribute; and
updating a variable with the value, wherein the variable is associated with the attribute.

21. The computer-readable medium of claim 20, wherein
the request includes an identifier;
the identifier identifies the attribute; and
based on the identifier, the printing device retrieves the value.

22. The computer-readable medium of claim 20, wherein the sending the request and receiving a response are performed using one of the following communication protocols: Simple Network Management Protocol, Universal Plug and Play, and Web Services Discovery.

23. The computer-readable medium of claim 20, wherein the printing device communicates with a database using the Simple Network Management Protocol.

24. The computer-readable medium of claim 20, wherein the request is sent to the
printing device upon the occurrence of one of the following events:
a driver associated with the printing device is installed;
a detection of an update on the printing device;
a particular input from a user is received; and
a completion of a scheduled cycle.

25. The computer-readable medium of claim 20, wherein the attribute of the print medium includes one of the following attributes: thickness, size, type, color, orientation, and whether a particular medium is pre-printed.

26. The computer-readable medium of claim 20, wherein generating a request comprises:
querying a configuration file associated with the printing device; and
retrieving, from the configuration file, an identifier that identifies the attribute.

27. The computer-readable medium of claim 26, wherein the configuration file is in XML format.

28. The computer-readable medium of claim 20, wherein:
a graphical user interface (GUI) is associated with the printing device; and
the variable corresponds to a GUI object associated with the GUI.

29. The computer-readable medium of claim 20, wherein the request identifies the input bin.

30. The computer-readable medium of claim 20, wherein:
the generating a request includes a printer driver generating the request;
the sending the request includes the printer driver sending the request;
the receiving a response includes the printer driver receiving the response; and
the updating a variable includes the printer driver updating the variable.

31. A computer-readable medium for the automatic discovery of a value of an attribute of a print medium, the computer-readable medium carrying one or more sequences of instructions which, when executed by one or more processors, cause the one or more processors to perform the computer-implemented steps of:
receiving, from a requesting process, a request for the value of the attribute, wherein the print medium is currently disposed in an input bin of a printing device;
retrieving the value from a database associated with the printing device; and
sending, to the requesting process, a response that includes the value.

32. The computer-readable medium of claim 31, wherein the database is a management information base (MIB).

33. The computer-readable medium of claim 31, wherein:
the request includes an identifier;
the identifier identifies the attribute; and
the retrieving the value from a database comprises retrieving the value from a database, based on the identifier.

34. The computer-readable medium of claim 31, wherein the receiving a request and the sending a response are performed using one of the following communication protocols: Simple Network Management Protocol, Universal Plug and Play, and Web Services Discovery.

35. The computer-readable medium of claim 31, wherein the retrieving the value from a database is performed using the Simple Network Management Protocol.

36. The computer-readable medium of claim 31, wherein the request is received upon the occurrence of one of the following events:
a driver associated with the printing device is installed;
a detection of an update on the printing device;
a particular input from a user is received; and
a completion of a scheduled cycle.

37. The computer-readable medium of claim 31, wherein the attribute includes one of the following attributes: thickness, size, type, color, orientation, and whether a particular medium is pre-printed.

38. The computer-readable medium of claim 31, wherein the request identifies the input bin.
